(19) United States
(12) Patent Application Publication
(10) Pub. No.: US 2008/0129128 A1
(43) Pub. Date: Jun. 5, 2008

(54) Coil Assembly for Use with an Electric Motor

(75) Inventors: Johan Cornis Compter, Eindhoven (NL); Petrus Carolus Maria Frissen, Eindhoven (NL); Rob Tabor, Eindhoven (NL); Frans Van Gaal, Eindhoven (NL); Hendrik Jan Eggink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/814,009

(22) PCT Filed: Jan. 13, 2006
(86) PCT No.: PCT/IB06/50133

§ 371 Date: Jul. 16, 2007

(30) Foreign Application Priority Data
Jan. 18, 2005 (EP) 05100264.0

(51) Int. Cl. H02K 5/20; H02K 9/19; H02K 41/02

(52) U.S. Cl. 310/54; 310/89

(57) ABSTRACT

Coil assemblies (2) of electric motors (1) produce heat that can be a disadvantage when needing the electric motor (1) for high precision positioning applications. To reduce the negative impact of the heat, the coils (26a, 26b, 26c) are arranged in an internally cooled housing (21). The housing (21) has an outermost layer (25) at least on the side lacing the magnet assembly (3) of the electric motor (1), the outermost layer (25) being made of low or non-electrically conductive, non-magnetic or nearly non-magnetic material. The outermost layer (25) prevents heat radiation to the environment.

The present invention relates to a coil assembly for use with an electric motor. Linear and planar electric motors are used for example in the semiconductor industry, and more particularly in lithographic devices.

One large field of application of electric motors is the transportation and positioning of semiconductor wafers during processing, especially photolithographic exposure. Electric motors comprise a coil assembly and a magnet assembly (one-dimensional for linear motors and two-dimensional for planar motors). If electric current is applied to the coil assembly, the generated Lorentz force induces a relative movement between coil assembly and magnet assembly.

The electric currents applied to the coil assembly generate heat that is emitted to the environment and adjacent components and induces thermal expansion. In high precision applications, like in semiconductor manufacturing, this thermal expansion can be large enough to make it impossible to attain the demanded high precision of positioning.

To cool the coil assembly, U.S. Pat. No. 6,313,550 B1 discloses a cover assembly that encircles the coils and the coil support and provides a portion of a fluid passageway for cooling each individual coil. The cover assembly includes a plurality of covers. Each cover is placed over and encircles a single individual coil and one of the coil supports. With this design, each cover provides for an individual fluid passageway around one coil. The cover forms a cover cavity which is sized and shaped to receive, encircle and fit over one coil and the coil support. It provides a portion of the fluid passage way between each cover and each coil for injecting the fluid to cool each individual coil. With this design, the temperature of each coil can be individually monitored and controlled by controlling the flow of the fluid in the passageway.

If directly cooling the individual coils with a fluid, especially in the long run, one has to take in account chemical reactions between fluid and coil material, that deteriorate the coils and the operability of the electric motor making use of such a coil assembly.

It is an object of the present invention to provide a coil assembly for use in electric motors allowing for high precision applications over a long life-time.

Accordingly, the invention provides a coil assembly for use with an electric motor, the coil assembly comprising an internally fluid-cooled housing, one or more coils in the housing, an outermost layer on the housing at least on the side to be facing a magnet assembly of an electric motor, the outermost layer being made of low or non-electrically conductive, non-magnetic or nearly non-magnetic material.

By using an internally fluid-cooled housing, sufficient heat removal is provided without the danger of chemical reactions between fluid and coil material, that would deteriorate the coil assembly and its operability in the long run.

To minimize the impact of heat not removed by the internally fluid-cooled housing an outermost layer is provided at least on the side to be facing a magnet assembly of an electric motor. This location is particularly sensitive with respect to heat radiation and high precision positioning, because in an electric motor, there is a thin layer of air between the coil assembly and the magnet assembly. The thermal expansion of the air leads to a change in the index of refraction. This reduces the accuracy of an interferometer system used to monitor the position and degrades the positioning accuracy of the electric motor.

By using low or non-electrically conductive, non-magnetic material for this outermost layer, on the one hand heat radiation to surrounding machine parts is prevented and on the other hand heat generation and damping due to eddy currents are reduced and a mechanical protection of the coils is obtained.

In preferred embodiments of the present invention, the housing is open to the side to be facing a magnet assembly of an electric motor and comprises a lid for closing the housing, the lid having the outermost layer being made of low or non-electrically conductive, no-magnetic material. In this design, the mounting of the coil assembly is facilitated, as the one or more coils can be put into the housing through the opening. The opening is then closed by the lid.

Preferably, the outermost layer is glued to the housing to achieve high voltage safety, compared to metallic fasteners like screws. These may lead to local field concentration, if their tips stand out of the plane they are fastened in. Another, but more expensive solution is to have the outermost layer deposited as coating, depending on the material of the outermost layer.

Preferred materials of the outermost layer are stainless steel, titanium or ceramics. Of these materials stainless steel is the best conductor, but also the less expensive and easiest to process material.

Preferred material of the housing is ceramics. Ceramics have shown to be most easily processed to get shapes with internal cooling channels. Besides, they have good thermal stability and work well especially with liquid fluids.

The preferred cooling fluid is water, as it is omnipresent, low cost and has a sufficient thermal conductivity.

In preferred embodiments, the housing is coated with metal to prevent heat radiation. The housing should be metal-coated at least at the sides in contact with the surrounding air and not covered by the outermost layer according to the invention.

Preferably, all the surfaces not covered by the outermost layer are metal-coated for most efficient prevention of heat radiation to surrounding machine parts.

In preferred embodiments, the one or more coils are foil coils to reduce heat generation.

Preferably, the one or more coils are made of aluminum. The weight reduction due to this choice of material leads to a reduction of coil currents. A further advantage of aluminum is that an oxide layer on the aluminum can act as a cheap and reliable insulation. Reduced coil currents, in turn, generate less heat. Another convenient material is copper, having a higher density than aluminum, but also a lower specific resistivity.

A detailed description of the invention is provided below. Said description is provided by way of a non-limiting example to be read with reference to the attached drawings in which:

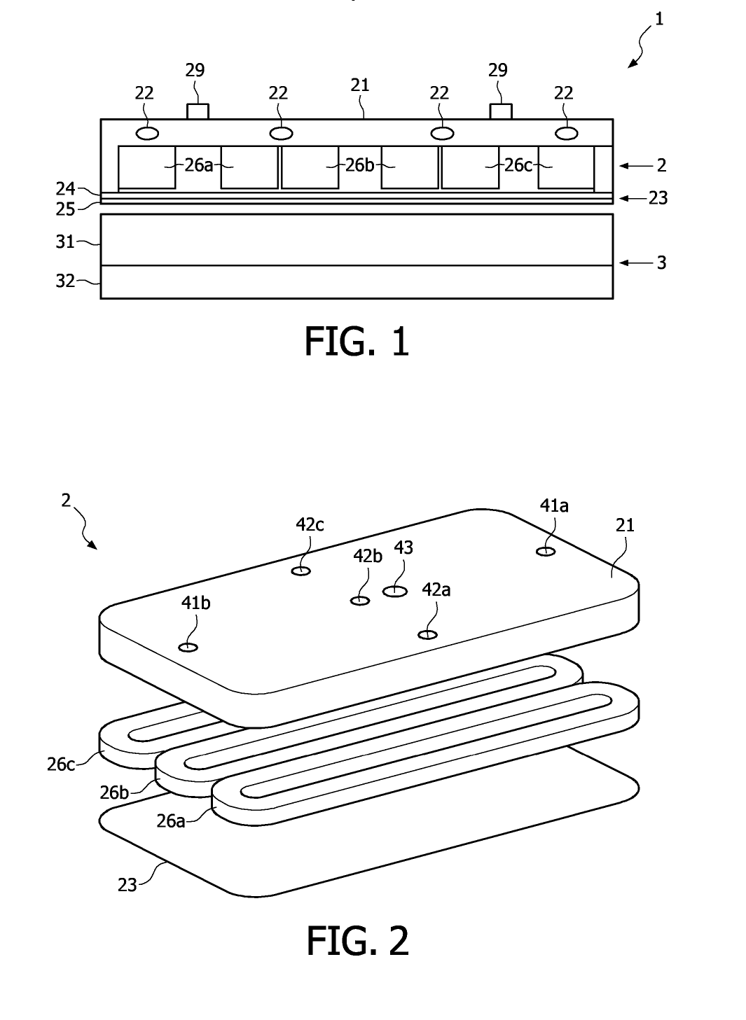

FIG. 1 shows schematically a cut through an electric motor with a coil assembly according to the invention;

FIG. 2 shows schematically an exploded view of a coil assembly according to the invention;

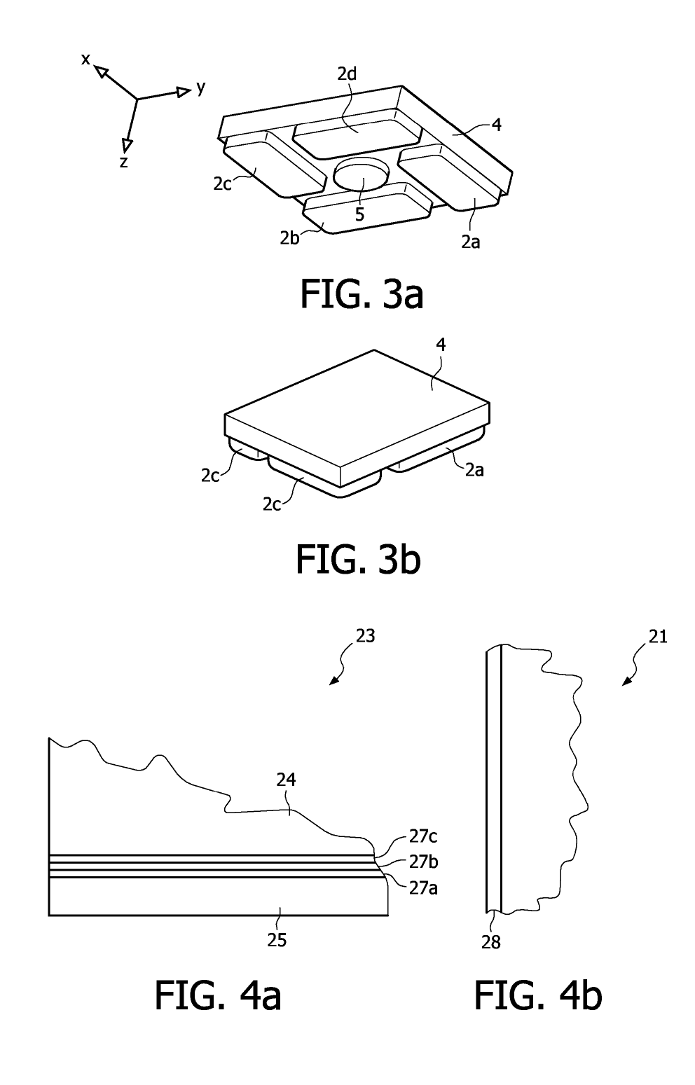

FIG. 3a shows schematically a carrier for an electric motor with coil assemblies according to the invention;

FIG. 3b shows the carrier of FIG. 3a from another perspective;

FIG. 4a shows schematically a detail of the lid; and

FIG. 4b shows schematically a detail of the housing.

FIG. 1 shows schematically an electric motor 1 with a coil assembly 2 according to the invention and a magnet assembly 3. The magnet assembly 3 comprises magnets 31 mounted on a steel plate 32 for returning the magnetic flux.

The coil assembly comprises a housing 21 with internal cooling channels 22 and a lid 23. In the present example, the housing 21 is made of silicon carbide, a ceramic material, and water is used as fluid coolant. Three coils 26a, 26b, 26c for 3-phases operation of the electric motor have been arranged in the housing 21 through the opening to be oriented towards the magnets 31 of the magnet assembly 3. It will be noted, that other modes of operation than 3-phase operation are possible as well. All three coils 26a, 26b, 26c are aluminum foil coils to minimize weight and heat production and to get reliable and well insulated coils.

The housing 21 is closed with help of a lid 23. The lid 23 of the present example has a main part 24 of the same material as the remaining housing, i.e. silicon carbide. As outermost layer 25 on the lid 23 a stainless steel plate has been glued. The stainless steel plate 25 should be thin enough to prevent heavy eddy current clamping, when the coil assembly 2 is moving with respect to the magnetic field. Besides, the coils 26a, 26b, 26c have to be as near as possible to the magnets 31 of the magnet assembly 3 to achieve maximum forces and maximum acceleration in the electric motor 1.

In the present example, sheet thicknesses of no more than ca. 0.2 mm have proven to be advantageous. Preferably, in the present case, the sheet has a thickness of 0.1 mm. The actual choice of thickness depends on the material of the outermost layer, the geometry and material of coils and housing, as well as on the coil currents and the magnetic field of the magnet assembly. Other preferred materials for the outermost layer are titanium or ceramics. It has to be an electrically low or non-conductive, non-magnetic or nearly non-magnetic material and be capable of withstanding mechanical stress induced by thermal gradients.

It will be noted that the housing 21 may have any other shape and that the outermost layer 25 may extend over more surfaces than in the present example.

As illustrated in FIG. 4a, the stainless steel plate 25 has been applied to the main body 24 of the lid 23 with glue. The glue has been applied in three layers 27a, 27b, 27c. This is done to further increase high voltage security. Smallest air bubbles could be enclosed in a layer of glue and lead to locally high electric fields. By applying at least two layers of glue, the air bubbles are distributed more evenly, and their size is on average smaller than in one thick layer. The glue layers 27a, 27b, 27c of the present example have thickness of approximately 0.1 mm.

If the coil assembly 2 is to be used in vacuum or clean room atmosphere like in semiconductor manufacturing industry, the glue should be chosen to show only low outgassing. The stainless steel plate 25 further prevents outgassing.

The outer surface of the housing 21 not covered by the stainless steel plate 25 is coated with metal to further prevent heat radiation to the surrounding air and motor parts as well as radiation to the parts of larger devices, in which the electric motor 1 is utilized. For example, in a lithographic apparatus thermal expansion of optical components could lead to defective exposures on the wafers. As the metallic coating 28 is quite thin, it is illustrated only in the detail shown in FIG. 4b.

In the example illustrated in FIG. 1, temperature sensors 29 are provided on the housing 21 of the coil assembly 2 for monitoring the temperature. If the temperature increases above a certain threshold, the power supplied is reduced to avoid overloading of the coil assembly 2 respectively the electric motor 1. It will be noted that the number and location of the temperature sensors 29 may be chosen freely depending on the actual application of the coil assembly 2, respectively of the electric motor 1.

FIG. 2 shows schematically an exploded view of the coil assembly 2. The coils 26a, 26b, 26c fit into the housing 21, which is to be closed by the lid 23. The housing 21 provides several connections of the coils assembly 2 to the infrastructure. In the present example, there are two water connections 41a, 41b that operate as water input and water output for the internal cooling channels. There are three power connections 42a, 42b, 42c, one for each coil 26a, 26b, 26c. And there is a cable connection 43, for example for the transmission of control signals.

FIG. 3a shows how four coil assemblies 2a, 2b, 2c, 2d can be arranged under a carrier 4. They are arranged to provide space in their middle for an electronic box 5. The electronic box 5 contains e.g. hall sensors for measuring the position of the carrier 4. The carrier 4 is part of a two stage electric motor. As bottom stage it moves in a long stroke over several tens of centimeters. On the carrier 4 is arranged a second stage (not shown) for short stroke movement in the range of submicrometers. With the help of interferometric position measurement, positioning with the accuracy of nm is achieved on the second stage.

The carrier 4 my be used for a planar electric motor having six degrees of freedom. Coil assemblies 2a, 2c are predominantly used for movement in Y-direction, coil assemblies 2b, 2d for movement in X-direction. All four coil assemblies 2a, 2b, 2c, 2d together can be used for controlling movement in Z-direction and in various combinations for tilting the carrier 4 in any direction.

As can be seen in FIG. 3b, showing the carrier 4 of FIG. 3a from a higher point of view, heat can radiate from under the carrier 4 from the sides of the coil assemblies 2a, 2c, 2d. Therefore, in the present example the housing 21 of the coil assemblies 2a, 2b, 2c, 2d is coated with metal as explained before. The coating prevents heat radiation to the surrounding air and to the carrier 4 carrying the high accuracy positioning second stage.

The coil assembly 2 of the present example is driven with currents leading to a total power of 375 W. Particularly with the help of the internally cooled housing 21 and the outermost layer 25 the heat transfer to the environment is efficiently reduced to 0.8% of the 375 W on the carrier side, to 0.3% on the vertical sides of the housing 21 and to 0.3% on the side facing the magnet assembly 3.

Although having described several preferred embodiments of the invention, those skilled in the art would appreciate that various changes, alterations, and substitutions can be made without departing from the spirit and concepts of the present invention. The invention is, therefore, claimed in any of its forms or modifications with the proper scope of the appended claims. For example various combinations of the features of the following dependent claims could be made with the features of the independent claim without departing from the scope of the present invention. Furthermore, any reference numerals in the claims shall not be construed as limiting scope.

### LIST OF REFERENCE NUMERALS

1 electric motor
2a,b,c,d coil assembly
3 magnet assembly
4 carrier
21 housing
22 internal cooling channel
23 lid
24 main component of lid
25 outermost layer
26a,b,c coil
27a,b,c glue
28 metal coating
29 temperature sensor
31 magnets
32 steel plate
41a,b water connection
42a,b,c power connection
43 cable connection

1. A coil assembly (2) for use with an electric motor (1), the coil assembly (2) comprising:
an internally fluid-cooled housing (21);
one or more coils (26a, 26b, 26c) in the housing (21);
an outermost layer (25) on the housing (21) at least on the side to be facing a magnet assembly (3) of an electric motor (1), the outermost layer (25) being made of low or non-electrically conductive, non-magnetic or nearly non-magnetic material.

2. The coil assembly according to claim 1, wherein the housing (21) is open to the side to be facing a magnet assembly (3) of an electric motor (1) and wherein the housing (21) comprises a lid (23) for closing the housing (21), the lid (23) comprising said outermost layer (25).

3. The coil assembly according to claim 1, wherein the outermost layer (25) is glued (27a, 27b, 27c) to the housing (21).

4. The coil assembly according to claim 1, wherein the outermost layer (25) is made of stainless steel, titanium or ceramics.

5. The coil assembly according to claim 1, wherein the housing (21) is made of ceramics.

6. The coil assembly according to claim 1, wherein the housing (21) is water-cooled.

7. The coil assembly according to claim 1, wherein the housing (21) is coated with metal (28).

8. The coil assembly according to claim 1, wherein the one or more coils (26a, 26b, 26c) are foil coils.

9. The coil assembly according to claim 1, wherein the one or more coils (26a, 26b, 26c) are made of aluminum.
